(19) United States
(12) Patent Application Publication
(10) Pub. No.: US 2023/0113259 A1
(43) Pub. Date: Apr. 13, 2023

(54) SYSTEM AND METHOD FOR ENDPOINT - SUPPLEMENTED DISTRIBUTED FINANCIAL COMPUTING

(71) Applicant: Brendan Galvin, Williamsburg, VA (US)

(72) Inventor: Brendan Galvin, Williamsburg, VA (US)

(21) Appl. No.: 17/961,532

(22) Filed: Oct. 6, 2022

Related U.S. Application Data
(60) Provisional application No. 63/254,158, filed on Oct. 10, 2021.

(51) Int. Cl. G06Q 40/06

(52) U.S. Cl. CPC G06Q 40/06

(57) ABSTRACT

A system and method for endpoint-supplemented distributed financial computing, comprising a plurality of financial institutions, a plurality of varied endpoints, an endpoint software distributor, and a preliminary analysis system. The system performs algorithmic analysis of financial data in two parts, first a preliminary analysis on the preliminary analysis system, and then a second portion of analysis on an endpoint running software delivered by the endpoint software distributor. The financial analysis may be performed with a single or plurality of financial institutions supplying base financial data to be analyzed, and the system may involve automated algorithms such as regularly-scheduled datamining algorithms in certain implementations.

### CROSS-REFERENCE TO RELATED APPLICATIONS

Priority is claimed in the application data sheet to the following patents or patent applications, the entire written description of each of which is expressly incorporated herein by reference in its entirety:

62/254,158

### BACKGROUND

### Field of the Art

The disclosure relates to the field of cloud computing, and more particularly to the field of financial analysis computing.

### Discussion of the State of the Art

It is commonplace in today's technologically advanced economy for business to offload difficult, or time-consuming, computation tasks to cloud computing services such as AMAZON WEB SERVICES™ or WINDOWS AZURE™. Such tasks may include complicated 3D modelling, the training of machine learning models including various forms of neural networks, and algorithmic analysis of large or real-time data sets, such as with financial data. It is common, as shown with firms such as QUANTCONNECT™, to offload entire tasks to a cloud platform and allow their computing to be used for a task such as backtesting an algorithm used to predict and make trades on the stock market. Backtesting comprises the use of historical stock market data to evaluate the trades and overall performance an algorithm would have made if you had utilized it during a specified time period, to gauge its success.

What is not shown however, is a system that can allow users to perform ad-hoc analyses that combines the use of their computing power, and the cloud platform provider, along with data from a possible multitude of financial sources, combining multi-tenancy, single-tenancy, and arbitration between multiple external sources of data, to provide for swift, high-quality, and easily accessible cyber-financial services.

### SUMMARY

Accordingly, the inventor has conceived and reduced to practice, a system and method for endpoint-supplemented distributed financial computing, comprising a plurality of financial institutions, a plurality of varied endpoints, an endpoint software distributor, and a preliminary analysis system. The system performs algorithmic analysis of financial data in two parts, first a preliminary analysis on the preliminary analysis system, and then a second portion of analysis on an endpoint running software delivered by the endpoint software distributor. The financial analysis may be performed with a single or plurality of financial institutions supplying base financial data to be analyzed, and the system may involve automated algorithms such as regularly-scheduled datamining algorithms in certain implementations.

According to one aspect, a system for endpoint-supplemented distributed financial computing, is disclosed, comprising: at least one datastore; a network endpoint comprising at least a first plurality of programming instructions stored in the at least one memory of, and operating on at least one processor of, the computer system, wherein the first plurality of programming instructions, when operating on the at least one processor, cause the computer system to: direct a web browser to a web address; wherein the web address is the Uniform Resource Locator for an endpoint software distributor; download executable software code distributed from an endpoint software distributor; execute the executable software code downloaded from an endpoint software distributor, within a web browser; send Representational State Transfer API requests over the Internet, using Hypertext Transfer Protocol and Hypertext Transfer Protocol Secure, to an endpoint software distributor; perform final analysis on received response form endpoint software distributor, using the downloaded executable software code; an endpoint software distributor comprising at least a second plurality of programming instructions stored in the at least one memory of, and operating on at least one processor of, the computer system, wherein the second plurality of programming instructions, when operating on the at least one processor, cause the computer system to: listen on Hypertext Transfer Protocol and Hypertext Transfer Protocol Secure ports for incoming requests, such as those from web browsers; serve a website to web browsers that attempt to access the endpoint software distributor's Uniform Resource Locator; serve executable software code to browsers attempting to access the endpoint software distributor's Uniform Resource Locator; listen for Representational State Transfer API requests sent by a network endpoint over the Internet; forward requests to an internal API maintained by a preliminary analysis system; forward internal responses from the preliminary analysis system to the network endpoint; and a preliminary analysis system comprising at least a third plurality of programming instructions stored in the at least one memory of, and operating on at least one processor of, the computer system, wherein the third plurality of programming instructions, when operating on the at least one processor, cause the computer system to: listen for requests from an endpoint software distributor; access data from a datastore, for the purposes of authenticating or fulfilling received requests; authenticate requests and user identities; communicate with at least one financial institution over the Internet, for requests requiring live financial data or other data from financial institutions; perform requested analysis of data; and respond to request received from endpoint software distributor.

Further, a method for endpoint-supplemented distributed financial computing is disclosed, comprising the steps of: directing a web browser to a web address, using a network endpoint; wherein the web address is the Uniform Resource Locator for an endpoint software distributor, using a network endpoint; downloading executable software code distributed from an endpoint software distributor, using a network endpoint; executing the executable software code downloaded from an endpoint software distributor, within a web browser, using a network endpoint; sending Representational State Transfer API requests over the Internet, using Hypertext Transfer Protocol and Hypertext Transfer Protocol Secure, to an endpoint software distributor, using a network endpoint; performing final analysis on received response form endpoint software distributor, using the downloaded executable software code, using a network endpoint; listening on Hypertext Transfer Protocol and Hypertext Transfer Protocol Secure ports for incoming requests, such as those from web browsers, using a endpoint software distributor; serving a website to web browsers that attempt to access the endpoint software distributor's Uniform Resource Locator, using a endpoint software distributor; serving executable software code to browsers attempting to access the endpoint software distributor's Uniform Resource Locator, using a endpoint software distributor; listening for Representational State Transfer API requests sent by a network endpoint over the Internet, using a endpoint software distributor; forwarding requests to an internal API maintained by a preliminary analysis system, using a endpoint software distributor; forwarding internal responses from the preliminary analysis system to the network endpoint, using a endpoint software distributor; listening for requests from an endpoint software distributor, using a preliminary analysis system; accessing data from a datastore, for the purposes of authenticating or fulfilling received requests, using a preliminary analysis system; authenticating requests and user identities, using a preliminary analysis system; communicating with at least one financial institution over the Internet, for requests requiring live financial data or other data from financial institutions, using a preliminary analysis system; performing requested analysis of data, using a preliminary analysis system; and responding to request received from endpoint software distributor, using a preliminary analysis system.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a system diagram illustrating an exemplary system architecture for endpoint-supplemented distributed financial computing, according to a preferred aspect.

FIG. 2 is a system diagram illustrating components and inner workings of a preliminary analysis system and an endpoint-accessible server, according to a preferred aspect.

FIG. 3 is a system diagram illustrating components and inner workings of a preliminary analysis system with an automated algorithm engine and an endpoint-accessible server, according to another aspect.

FIG. 4 is a method diagram illustrating steps used in the operation of an exemplary system architecture for endpoint-supplemented distributed financial computing, according to a preferred aspect.

FIG. 5 is a method diagram illustrating steps used in the operation of a preliminary analysis system and an endpoint-accessible server, according to a preferred aspect.

FIG. 6 is a method diagram illustrating steps used in the operation of a preliminary analysis system with an automated algorithm engine and an endpoint-accessible server, according to another aspect.

FIG. 7 is a block diagram illustrating an exemplary hardware architecture of a computing device.

FIG. 8 is a block diagram illustrating an exemplary logical architecture for a client device.

FIG. 9 is a block diagram showing an exemplary architectural arrangement of clients, servers, and external services.

FIG. 10 is another block diagram illustrating an exemplary hardware architecture of a computing device.

### DETAILED DESCRIPTION

The inventor has conceived, and reduced to practice, a system and method for endpoint-supplemented distributed financial computing.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

“Artificial intelligence” or “AI” as used herein means a computer system or component that has been programmed in such a way that it mimics some aspect or aspects of cognitive functions that humans associate with human intelligence, such as learning, problem solving, and decision-making. Examples of current AI technologies include understanding human speech, competing successfully in strategic games such as chess and Go, autonomous operation of vehicles, complex simulations, and interpretation of complex data such as images and video.

“Machine learning” as used herein is an aspect of artificial intelligence in which the computer system or component can modify its behavior or understanding without being explicitly programmed to do so. Machine learning algorithms develop models of behavior or understanding based on information fed to them as training sets, and can modify those models based on new incoming information. An example of a machine learning algorithm is AlphaGo, the first computer program to defeat a human world champion in the game of Go. AlphaGo was not explicitly programmed to play Go. It was fed millions of games of Go, and developed its own model of the game and strategies of play.

“Neural network” as used herein means a computational model, architecture, or system made up of a number of simple, highly interconnected processing elements which process information by their dynamic state response to external inputs, and is thus able to “learn” information by recognizing patterns or trends. Neural networks, also sometimes known as “artificial neural networks” are based on our understanding of the structure and functions of biological neural networks, such as the brains of mammals. A neural network is a framework for application of machine learning algorithms.

“Backtesting” as used herein refers to the practice of gathering historical financial data, and running a financial algorithm (such as an automated stock market trading algorithm) on the historical data for a set time period, and measuring the outcome of the algorithm when run over that period of time based on the actual historical data for how markets behaved in that time period. Backtesting is done by financial analysts to determine the efficacy of algorithms for a given span of time and for certain market conditions or market behaviors, often for timespans of over one year, to help determine if the algorithm is likely to perform well in the future.

“Financial institution” as used herein may refer to a bank, a stock brokerage, a broker-dealer, a market maker, a stock exchange, a credit union, an analysis firm, or any related firms, services, or people in the economy that may be commonly referred to collectively or singly as a “financial institution.”

### Conceptual Architecture

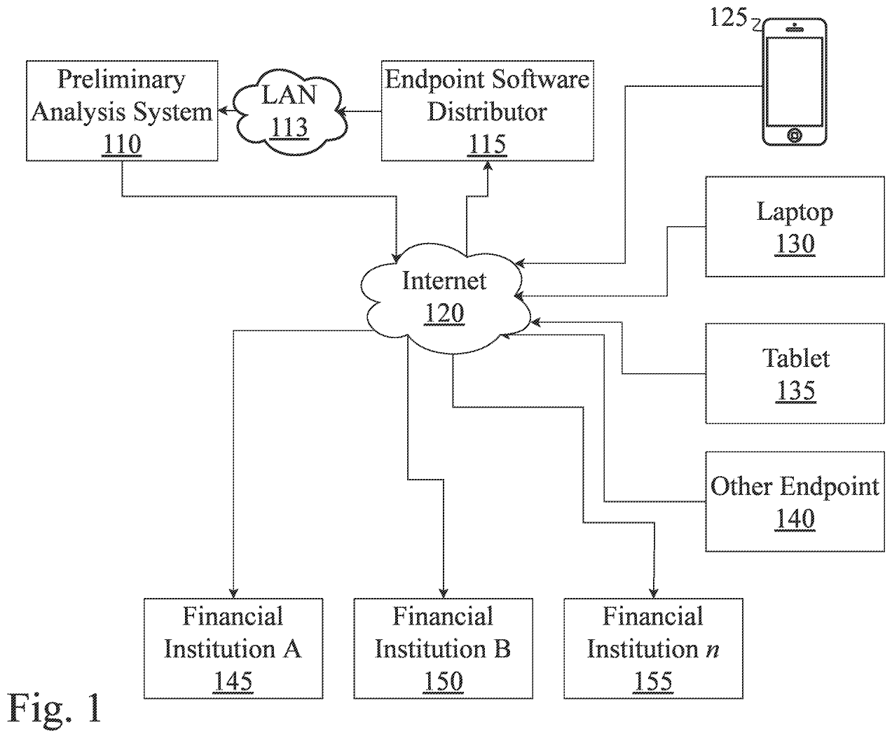

FIG. 1 is a system diagram illustrating an exemplary system architecture for endpoint-supplemented distributed financial computing, according to a preferred aspect. A preliminary analysis system 110 exists as a computing device, or collection of computing devices, such as a server or multiple servers, such as those that may operate in a datacenter. It may utilize an operating system such as any of the WINDOWS™ operating systems, one of the many LINUX™ operating systems, or other operating systems. A Local Area Network (“LAN”) 113 connects the preliminary analysis system 110 to an endpoint software distributor 115. An endpoint software distributor may further exist as a separate server or other computing device, or the endpoint software distributor 115 and preliminary analysis system 110 may be hosted on the same device, with no LAN between them. The endpoint software distributor 115 may receive communications from endpoint devices that users may use to access web services, including but not limited to a smartphone 125, laptop 130, tablet computer 135, and other endpoint devices 140 such as non-mobile computing devices. Such endpoints 125, 130, 135, 140 may individually access the endpoint software distributor 115 over the Internet 120, with a web browser, at which point the distributor 115 will upload executable software code, such as a combination of WEBASSEMBLY™, JAVASCRIPT™, and other code, aside from or in addition to regular HTML and CSS markup for the rendering of webpages. The code will be executed in the endpoint's 125, 130, 135, 140 web browser, as a web application. The preliminary analysis system may, when needed, communicate and make requests over the Internet 120 to at least one of a possible plurality of financial institutions 145, 150, 155, which may be any of a combination of stock brokerages, brokerage-dealers, banks, credit unions, market makers, or other financial institutions. A preliminary analysis system 110 may be used to gather data for fulfilling requests by user endpoints 125, 130, 135, 140, whether on a regular schedule (such as regularly scheduled datamining algorithms) or whether data gathering is performed on a per-request basis, from a possible plurality of financial institutions 145, 150, 155. Such information may include user account data, stock market data, data on stock derivatives, data on traded commodities, fundamental data such as company or business metrics and reports (such as those published by the United States Securities and Exchange Commission), or other financial data.

Data sent from financial institutions 145, 150, 155 to a preliminary analysis system 110 may be analyzed partially or fully based on user requests, or may only partially analyze data, before sending the result of the fulfilled requests back to the endpoint software distributor 115 over a LAN 113, which then sends results through the Internet 120 to the endpoint that originated the API request 125, 130, 135, 140. The endpoints may then either render the results of the request, finish the partially-completed analysis, or perform some other function, using the software distributed to the endpoints by the endpoint software distributor 115.

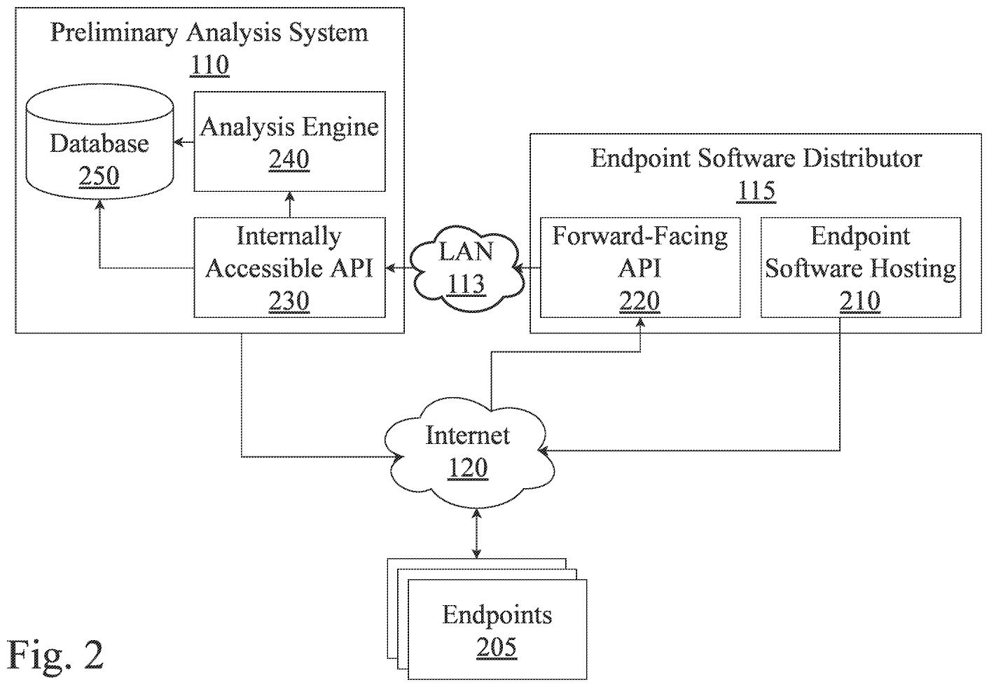

FIG. 2 is a system diagram illustrating components and inner workings of a preliminary analysis system and an endpoint-accessible server, according to a preferred aspect. A collection of endpoints 205, may individually or together send requests through the Internet 120 to an endpoint software distributor 115 over HTTP or HTTPS protocols, for software such as a web service or web application hosted 210 by the endpoint software distributor 120. Software is then distributed by the endpoint software distributor 120, and downloaded by the endpoint(s) 205. This software executes in the browser, and may be a combination of WEBASSEMBLY™ compiled or intermediate code, JAVASCRIPT™ code, HTML and CSS stylings, or other web technologies designed to deliver software to the browser for execution. As this software executes and interacts with the user or users of the endpoint(s), the endpoint(s) send requests over HTTP, HTTPS, or TCP/IP protocols to the endpoint software distributor 120, to a forward-facing Application Programming Interface (“API”) 220. The requests may be for user data or other user interactions within the system, or for financial analysis and data. Regardless of the nature of the requests received by the forward-facing API 220, if they are deemed valid and authorized requests, they may be forwarded over a LAN 113 to the preliminary analysis system 110 for processing, via an internally accessible API 230 in the preliminary analysis system 110. The internally accessible API 230 may receive the requests forwarded from the endpoint software distributor 115, and use an analysis engine 240 to process them, either completely using already-stored data within a datastore or database 250, or with the addition of financial data that may be gathered from financial institutions. The analysis may comprise filtering of financial assets according to user specifications, datamining algorithms operating on lists of assets or entities, finding entities that match certain criteria, performing normalization on large datasets for graphing or use of the dataset in machine learning algorithms, and machine learning algorithms themselves. The results of the analysis may be stored in the database 250, and may be forwarded back through the internal API 230 as the result of the initial call made by the endpoint software distributor 115, which then relays the result of the request and analysis back to the endpoint(s) 205. Such endpoints may execute the software downloaded from the endpoint software distributor 115 to finalize or alter the analysis or results received from the preliminary analysis system 110 as needed, allowing for distributed and decentralized processing of financial data. The database 250 need not be part of the same physical system as other components in the preliminary analysis engine 110, it would be sufficient for a network connection to exist between a database host and the preliminary analysis system 110, which is common in the art for networked software services.

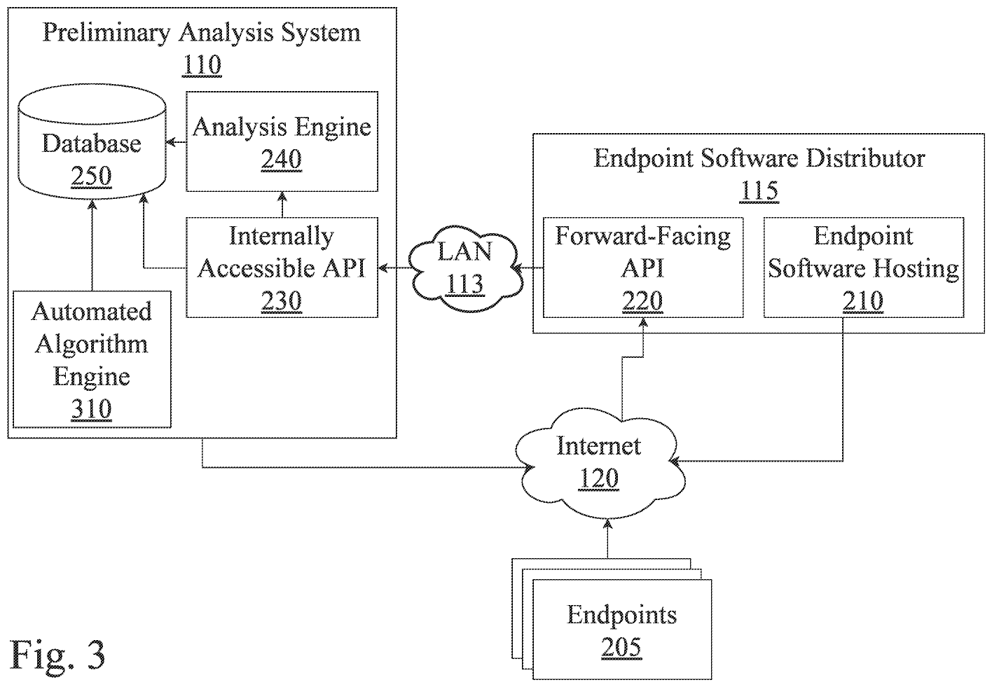

FIG. 3 is a system diagram illustrating components and inner workings of a preliminary analysis system with an automated algorithm engine and an endpoint-accessible server, according to another aspect. A collection of endpoints 205, may individually or together send requests through the Internet 120 to an endpoint software distributor 115 over HTTP or HTTPS protocols, for software such as a web service or web application hosted 210 by the endpoint software distributor 120. Software is then distributed by the endpoint software distributor 120, and downloaded by the endpoint(s) 205. This software executes in the browser, and may be a combination of WEBASSEMBLY™ compiled or intermediate code, JAVASCRIPT™ code, HTML and CSS stylings, or other web technologies designed to deliver software to the browser for execution. As this software executes and interacts with the user or users of the endpoint(s), the endpoint(s) send requests over HTTP, HTTPS, or TCP/IP protocols to the endpoint software distributor 120, to a forward-facing Application Programming Interface (“API”) 220. The requests may be for user data or other user interactions within the system, or for financial analysis and data. Regardless of the nature of the requests received by the forward-facing API 220, if they are deemed valid and authorized requests, they may be forwarded over a LAN 113 to the preliminary analysis system 110 for processing, via an internally accessible API 230 in the preliminary analysis system 110. The internally accessible API 230 may receive the requests forwarded from the endpoint software distributor 115, and use an analysis engine 240 to process them, either completely using already-stored data within a datastore or database 250, or with the addition of financial data that may be gathered from financial institutions. The analysis may comprise filtering of financial assets according to user specifications, datamining algorithms operating on lists of assets or entities, finding entities that match certain criteria, performing normalization on large datasets for graphing or use of the dataset in machine learning algorithms, and machine learning algorithms themselves. The results of the analysis may be stored in the database 250, and may be forwarded back through the internal API 230 as the result of the initial call made by the endpoint software distributor 115, which then relays the result of the request and analysis back to the endpoint(s) 205. Such endpoints may execute the software downloaded from the endpoint software distributor 115 to finalize or alter the analysis or results received from the preliminary analysis system 110 as needed, allowing for distributed and decentralized processing of financial data. The database 250 need not be part of the same physical system as other components in the preliminary analysis engine 110, it would be sufficient for a network connection to exist between a database host and the preliminary analysis system 110, which is common in the art for networked software services.

Further, an automated algorithm engine 310 exists as part of a preliminary analysis system 110, and may operate algorithms including regular datamining algorithms, volume alert algorithms and alerts, or other algorithms, on a regular schedule or with regular listening for data from financial institutions, to record the results in the database 250 upon algorithm execution. The data contained in the database 250 resulting from the automated algorithm engine 310 may be queried and viewed by authorized endpoints 205 based on their requests to the forward-facing API 220, for instance if an authenticated and authorized user wished to see the latest results from an always-running datamining algorithm, the query would read the latest data from the database 250 and return it to the user, while the automated algorithm engine 310 has no direct contact with the users or endpoints 205. The automated algorithm engine 310 does not need to be physically part of the same computing device or server as the other components in the preliminary analysis engine, and in fact may be a completely separate device, with a network connection to the database 250 and an Internet 120 connection utilized for the automated algorithms.

### Detailed Description of Exemplary Aspects

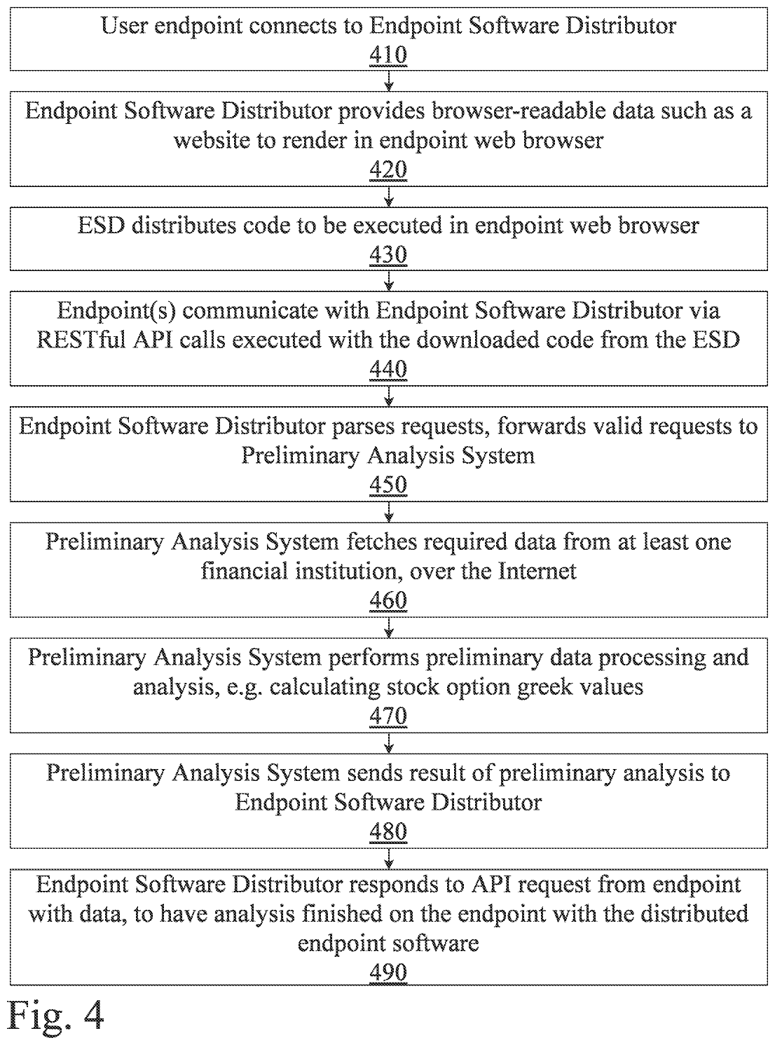

FIG. 4 is a method diagram illustrating steps used in the operation of an exemplary system architecture for endpoint-supplemented distributed financial computing, according to a preferred aspect. A collection of endpoints, may individually or together send requests through the Internet to an endpoint software distributor over HTTP or HTTPS protocols, for software such as a web service or web application hosted by the endpoint software distributor 410. An endpoint software distributor may provide browser-readable data such as a website to render in endpoint web browser 420, such as how web servers commonly operate for websites on the World Wide Web. This data may be secured using HTTPS protocol and proper encryption standards, and may be dynamically generated as opposed to static, or a combination of static and dynamic content, such as a Single-Page Application (“SPA”) or a Progressive Web Application (“PWA”). An endpoint software distributor may then, based on user interactions or as a default mode of behavior, distribute code to be executed in endpoint web browser 430 separate from merely website markup, such as JAVASCRIPT™, compiled WEBASSEMBLY™, and other software code that may operate within a web browser. Different code may be distributed to users of different operating systems or web browsers, or may be uniform across all platforms and web browsers. From this web-browser-executable code, the endpoint or endpoints may communicate with the endpoint software distributor via Representational State Transfer or “RESTful” API calls 440, sent over one or multiple of a variety of protocols that may include HTTP, HTTPS, TCP/IP, UDP, or other protocols. The endpoint software distributor may then parse the received requests from the endpoint or endpoints, to determine their validity, safety, and/or proper encryption, before forwarding such valid requests to a preliminary analysis system 450. Such forwarding may occur over a Local Area Network (LAN), or may occur over a computer bus if the preliminary analysis system and endpoint software distributor are built as a single computing device rather than separate devices. Such forwarding may be encrypted between the distributor and analysis system. A preliminary analysis system may then, based on the received request that was forwarded from the endpoint software distributor, fetch any required data from at least one financial institution, over the Internet 460, for the fulfillment of the endpoint request. Data may also be gathered from a connected or local database, whether for endpoint or user authorization and verification, or for processing the received request. A preliminary analysis system may then perform preliminary data processing and analysis, such as calculating stock option Greek values, calculating 3-dimensional graphs of stock option chain data, running machine learning algorithms, or other possible data analyses 470. Such analysis need may not be complete, and may comprise only a basic-level or partial analysis, such as filtering out certain financial assets or compiling financial data on a business or class of asset, before referring the results of the preliminary analysis back to the endpoint software distributor 480. Such an endpoint software distributor may then respond to the initial API request from the endpoint or endpoints with the data of the response, at which point the endpoint may, if needed, complete the analysis or perform additional analyses on the received data, using the distributed endpoint software operating in the web browser 490.

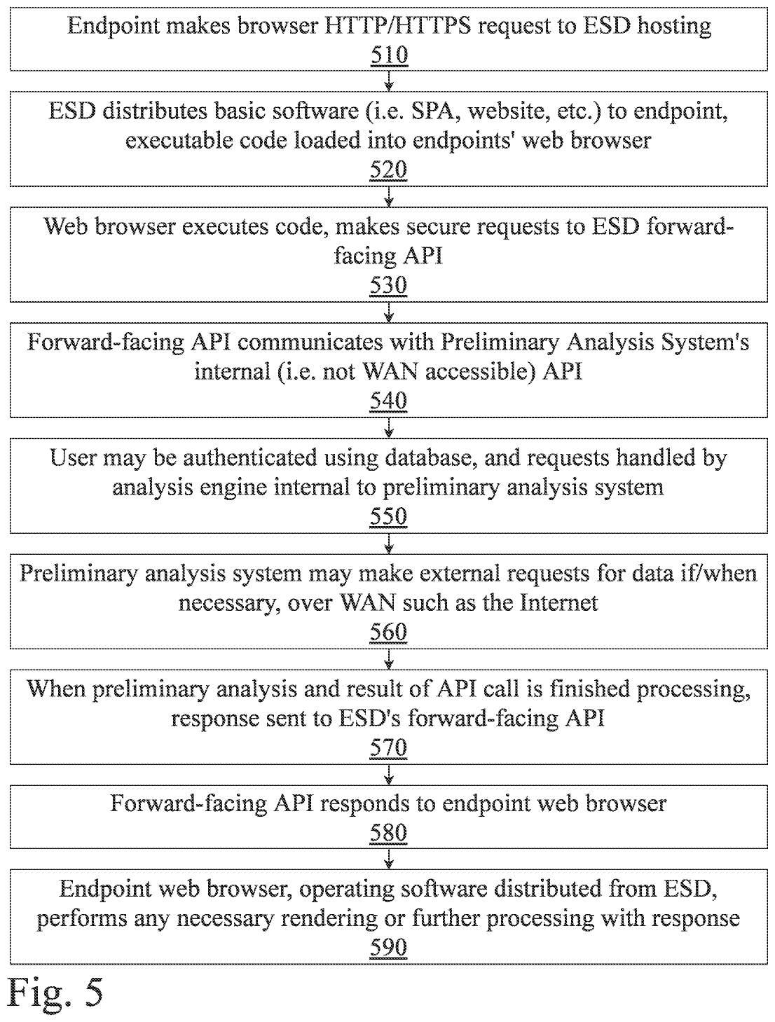

FIG. 5 is a method diagram illustrating steps used in the operation of a preliminary analysis system and an endpoint-accessible server, according to a preferred aspect. A collection of endpoints, may individually or together send requests through the Internet to an endpoint software distributor over HTTP or HTTPS protocols, for software such as a web service or web application hosted by the endpoint software distributor 510. Software is then distributed by the endpoint software distributor, and downloaded by the endpoint(s) 520. This software executes in the browser 530, and may be a combination of WEBASSEMBLY™ compiled or intermediate code, JAVASCRIPT™ code, HTML and CSS stylings, or other web technologies designed to deliver software to the browser for execution. As this software executes and interacts with the user or users of the endpoint(s), the endpoint(s) send requests over HTTP, HTTPS, or TCP/IP protocols to the endpoint software distributor, to a forward-facing Application Programming Interface (“API”) 540. The requests may be for user data or other user interactions within the system, or for financial analysis and data. Regardless of the nature of the requests received by the forward-facing API, if they are deemed valid and authorized requests 550 such as with a database or datastore containing user information that may be checked against to verify users, they may be forwarded over a LAN to the preliminary analysis system for processing, via an internally accessible API in the preliminary analysis system 550. The internally accessible API may receive the requests forwarded from the endpoint software distributor, and use an analysis engine to process them, either completely using already-stored data within a datastore or database, or with the addition of financial data that may be gathered from financial institutions, or some combination of both 560. The analysis may comprise filtering of financial assets according to user specifications, datamining algorithms operating on lists of assets or entities, finding entities that match certain criteria, performing normalization on large datasets for graphing or use of the dataset in machine learning algorithms, and machine learning algorithms themselves. The results of the analysis may be stored in the database, and may be forwarded back through the internal API as the result of the initial call made by the endpoint software distributor, which then relays the result of the request and analysis back to the endpoint(s) 570, 580. Such endpoints may execute the software downloaded from the endpoint software distributor to finalize or alter the analysis or results received from the preliminary analysis system as needed, allowing for distributed and decentralized processing of financial data 590. The database need not be part of the same physical system as other components in the preliminary analysis engine, it would be sufficient for a network connection to exist between a database host and the preliminary analysis system, which is common in the art for networked software services.

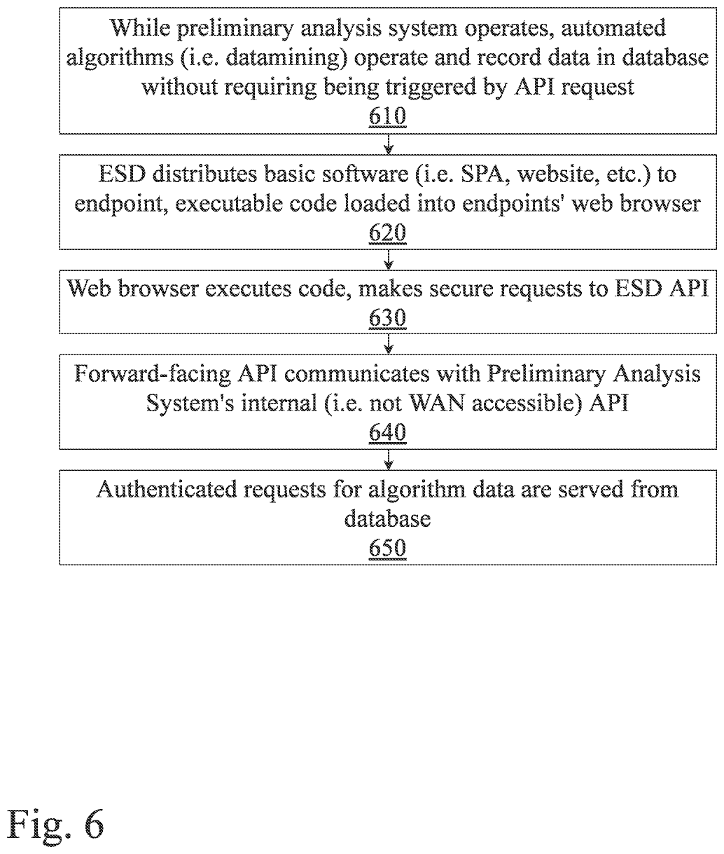

FIG. 6 is a method diagram illustrating steps used in the operation of a preliminary analysis system with an automated algorithm engine and an endpoint-accessible server, according to another aspect. A collection of endpoints, may individually or together send requests through the Internet to an endpoint software distributor over HTTP or HTTPS protocols, for software such as a web service or web application hosted by the endpoint software distributor. Software is then distributed by the endpoint software distributor, and downloaded by the endpoint(s) 620. This software executes in the browser, and may be a combination of WEBASSEMBLY™ compiled or intermediate code, JAVASCRIPT™ code, HTML and CSS stylings, or other web technologies designed to deliver software to the browser for execution. As this software executes and interacts with the user or users of the endpoint(s), the endpoint(s) send requests over HTTP, HTTPS, or TCP/IP protocols to the endpoint software distributor, to a forward-facing Application Programming Interface (“API”) 630. The requests may be for user data or other user interactions within the system, or for financial analysis and data. Regardless of the nature of the requests received by the forward-facing API, if they are deemed valid and authorized requests, they may be forwarded over a LAN to the preliminary analysis system for processing, via an internally accessible API in the preliminary analysis system 640. In this use case, the requests may involve data that has been processed or gathered from automated algorithms, either fully or in part. The internally accessible API may receive the requests forwarded from the endpoint software distributor, and use an analysis engine to process them, either completely using already-stored data within a datastore or database, or with the addition of financial data that may be gathered from financial institutions, or some combination of both. The analysis may comprise filtering of financial assets according to user specifications, datamining algorithms operating on lists of assets or entities, finding entities that match certain criteria, performing normalization on large datasets for graphing or use of the dataset in machine learning algorithms, and machine learning algorithms themselves. The results of the analysis may be stored in the database, and may be forwarded back through the internal API as the result of the initial call made by the endpoint software distributor, which then relays the result of the request and analysis back to the endpoint(s). Such endpoints may execute the software downloaded from the endpoint software distributor to finalize or alter the analysis or results received from the preliminary analysis system as needed, allowing for distributed and decentralized processing of financial data. The database need not be part of the same physical system as other components in the preliminary analysis engine, it would be sufficient for a network connection to exist between a database host and the preliminary analysis system, which is common in the art for networked software services.

Further, an automated algorithm engine exists as part of a preliminary analysis system, and may operate algorithms including regular datamining algorithms, volume alert algorithms and alerts, or other algorithms, on a regular schedule or with regular listening for data from financial institutions, to record the results in the database upon algorithm execution 610. The data contained in the database resulting from the automated algorithm engine may be queried and viewed by authorized endpoints based on their requests to the forward-facing API 650, for instance if an authenticated and authorized user wished to see the latest results from an always-running datamining algorithm, the query would read the latest data from the database and return it to the user, while the automated algorithm engine has no direct contact with the users or endpoints. The automated algorithm engine does not need to be physically part of the same computing device or server as the other components in the preliminary analysis engine, and in fact may be a completely separate device, with a network connection to the database and an Internet connection utilized for the automated algorithms.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

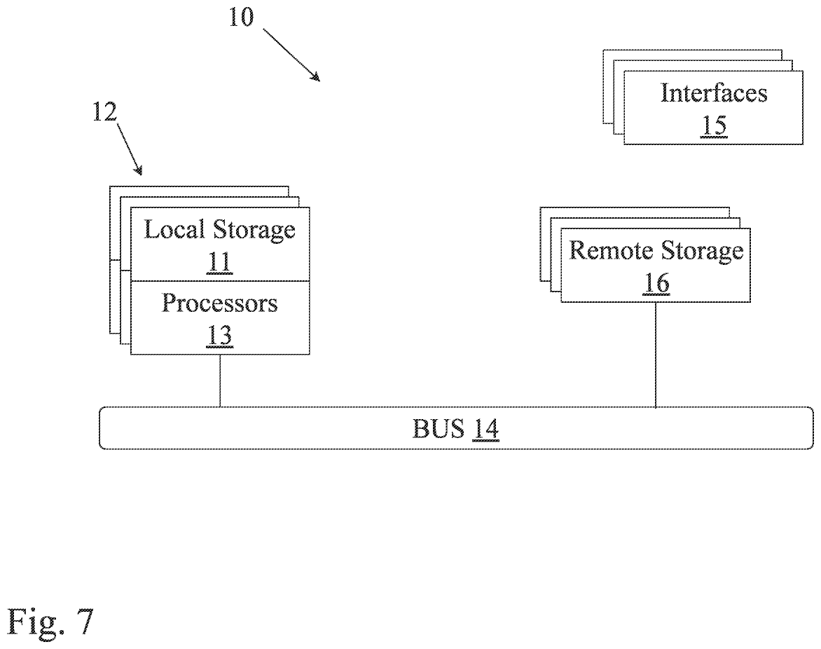

Referring now to FIG. 7, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like. CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 7 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

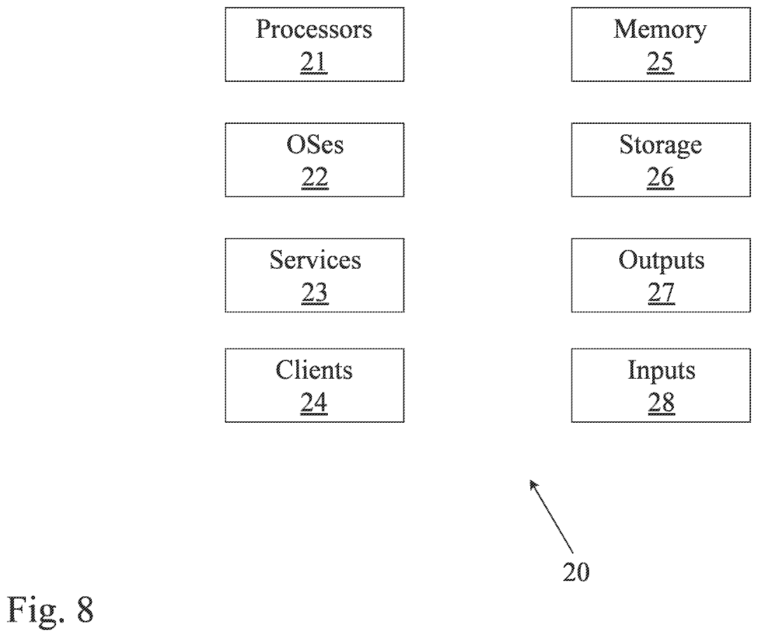

In some aspects, systems may be implemented on a standalone computing system. Referring now to FIG. 8, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 7). Examples of storage devices 26 include flash memory, magnetic hard drive, CD-ROM, and/or the like.

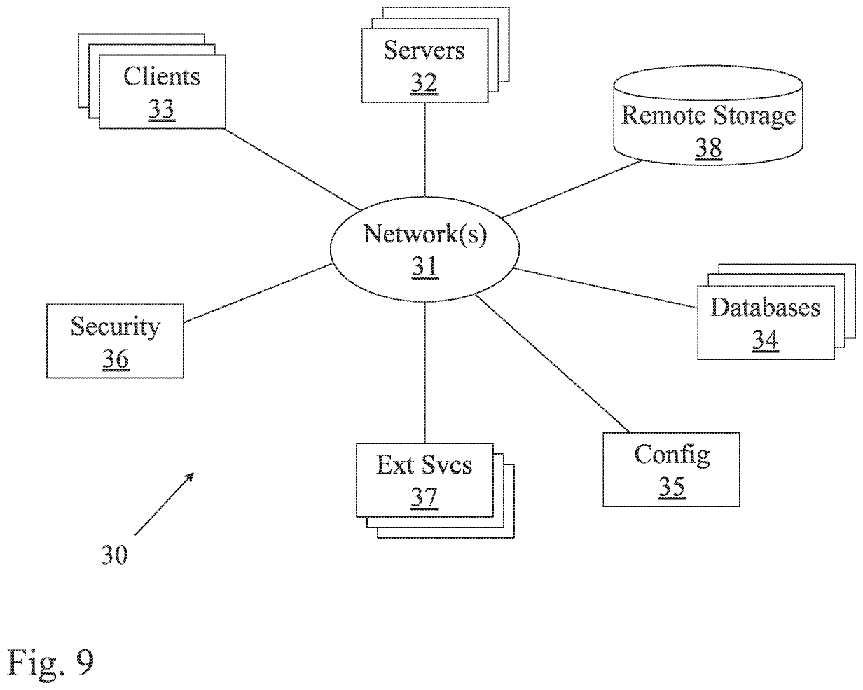

In some aspects, systems may be implemented on a distributed computing network, such as one having any number of clients and/or servers. Referring now to FIG. 9, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 8. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and using a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

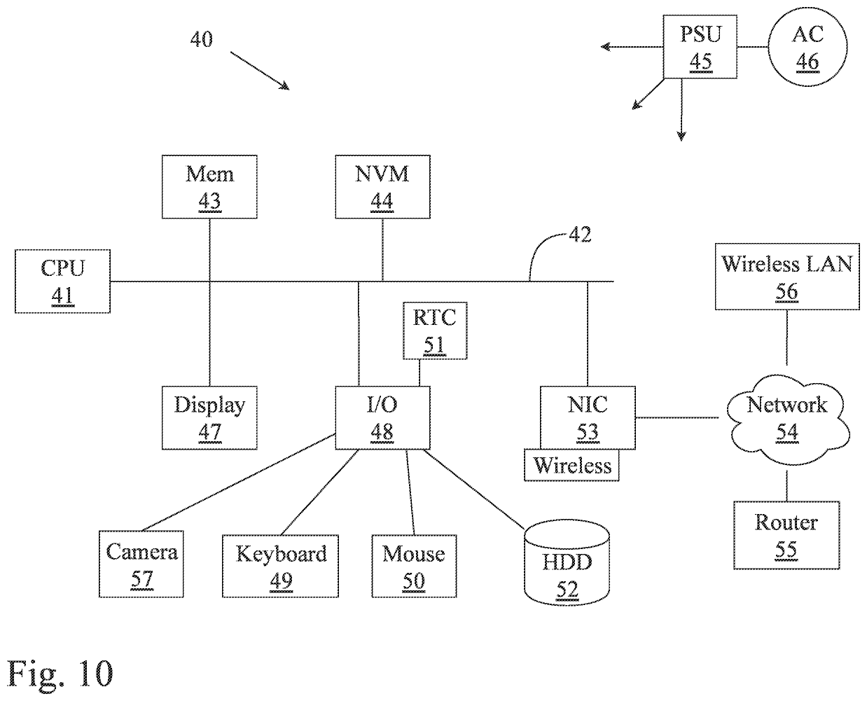

FIG. 10 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for endpoint-supplemented distributed financial computing, comprising:
at least one datastore;
a network endpoint comprising at least a first plurality of programming instructions stored in at least one memory of, and operating on at least one processor of, the computer system, wherein the first plurality of programming instructions, when operating on the at least one processor, cause the computer system to:
execute an application capable of communicating with a web server or servers over the Internet;
access an Internet-accessible resource using the executed application;
download data including data that instructs the network endpoint how to execute or configure software distributed from an endpoint software distributor;
send data access requests over the Internet to an endpoint software distributor; and
perform analysis on a received response from the endpoint software distributor, using algorithms that are configured or executed from the downloaded data;
the endpoint software distributor comprising at least a second plurality of programming instructions stored in the at least one memory of, and operating on at least one processor of, the computer system, wherein the second plurality of programming instructions, when operating on the at least one processor, cause the computer system to:
receive an incoming connection from the network endpoint;
upload data to the network endpoint including data that instructs the network endpoint how to execute or configure software;
forward data access requests received from the network endpoint to a preliminary analysis system; and
forward responses from the preliminary analysis system to the network endpoint; and
the preliminary analysis system comprising at least a third plurality of programming instructions stored in the at least one memory of, and operating on at least one processor of, the computer system, wherein the third plurality of programming instructions, when operating on the at least one processor, cause the computer system to:
receive requests from endpoint software distributor;
authenticate received requests and corresponding user identities;
request live financial data from at least one financial institution;
perform requested analysis of the received live financial data; and
respond to the requests received from endpoint software distributor.

2. The system of claim 1, further comprising:
an automated algorithm engine comprising at least a fourth plurality of programming instructions stored in the at least one memory of, and operating on at least one processor of, the computer system, wherein the fourth plurality of programming instructions, when operating on the at least one processor, cause the computer system to:
communicate with at least one financial institution over the Internet, for algorithms utilizing live financial data or other data from financial institutions;
execute financial analysis algorithms on a regular schedule, regardless of received requests; and
store the results of the algorithms in the datastore.

3. The system of claim 1, wherein the endpoint software distributor and preliminary analysis system are part of same computer system.

4. The system of claim 1, wherein the endpoint software distributor and preliminary analysis system are comprised of separate computer systems, such as different servers, communicating over a network.

5. The system of claim 1, wherein the endpoint software distributor and preliminary analysis system are hosted on virtual machines.

6. The system of claim 2, wherein the automated algorithm engine is on a separate physical device, such as a server, from the preliminary analysis system, wherein the two communicate over a network.

7. The system of claim 2, wherein the automated algorithm engine is hosted on the same physical device as the preliminary analysis system.

8. The system of claim 2, wherein the automated algorithm engine runs on a virtual machine.

9. The system of claim 1, wherein the communications between the preliminary analysis system and financial institutions occur over a network or medium other than the Internet.

10. The system of claim 1, wherein the datastore is hosted separately from the preliminary analysis system.

11. A method for endpoint-supplemented distributed financial computing, comprising the steps of:
executing an application capable of communicating with a web server or servers over the Internet, using a network endpoint;
accessing an Internet-accessible resource using the executed application, using a network endpoint;
downloading data including data that instructs the network endpoint how to execute or configure software, distributed from an endpoint software distributor, using a network endpoint;
sending data access requests such as Hypertext Transfer Protocol requests over the Internet, to an endpoint software distributor, using a network endpoint;
performing analysis on a received response from endpoint software distributor, using methods or algorithms that are instructed, configured, entirely executed from, or partially executed from the downloaded data that instructs the network endpoint how to execute or configure software, using a network endpoint;
listening for incoming connections from computing devices, including a network endpoint, using an endpoint software distributor;
allowing a network endpoint to download data including data that instructs the network endpoint how to execute or configure software, using an endpoint software distributor;
responding to data access requests over the Internet, using an endpoint software distributor;
serving data including data that instructs the network endpoint how to execute or configure software, to devices including network endpoints, using an endpoint software distributor;
listening for data access requests over the Internet such as Hypertext Transfer Protocol requests, using an endpoint software distributor;
forwarding data access requests to a preliminary analysis system, using an endpoint software distributor;
forwarding responses from the preliminary analysis system to the network endpoint, using an endpoint software distributor;
listening for requests from an endpoint software distributor, using a preliminary analysis system;
accessing data from a datastore, for the purposes of authenticating or fulfilling received requests, using a preliminary analysis system;
authenticating requests and user identities, using a preliminary analysis system;
communicating with at least one financial institution over the Internet, for requests requiring live financial data or other data from financial institutions, using a preliminary analysis system;
performing requested analysis of data, using a preliminary analysis system; and
responding to request received from endpoint software distributor, using a preliminary analysis system.

12. The method of claim 11, further comprising:
communicating with at least one financial institution over the Internet, for algorithms utilizing live financial data or other data from financial institutions, using an automated algorithm engine;
executing financial analysis algorithms on a regular schedule, regardless of received requests, using an automated algorithm engine; and
storing the results of the algorithms in the datastore, using an automated algorithm engine.

13. The method of claim 11, wherein the endpoint software distributor and preliminary analysis system are part of same computer system.

14. The method of claim 11, wherein the endpoint software distributor and preliminary analysis system are comprised of separate computer systems, such as different servers, communicating over a network.

15. The method of claim 11, wherein the endpoint software distributor and preliminary analysis system are hosted on virtual machines.

16. The method of claim 12, wherein the automated algorithm engine is on a separate physical device, such as a server, from the preliminary analysis system, wherein they communicate over a network.

17. The method of claim 12, wherein the automated algorithm engine is hosted on the same physical device as the preliminary analysis system.

18. The method of claim 12, wherein the automated algorithm engine runs on a virtual machine.

19. The method of claim 11, wherein the communications between the preliminary analysis system and financial institutions occur over a network or medium other than the Internet.

20. The method of claim 11, wherein the datastore is hosted separately from the preliminary analysis system.
